(19) United States
(12) Patent Application Publication
(10) Pub. No.: US 2025/0034485 A1
(43) Pub. Date: Jan. 30, 2025

(54) FABRIC SOFTENING COMPOSITION

(71) Applicant: Conopco, Inc., d/b/a UNILEVER, Englewood Cliffs, NJ (US)

(72) Inventors: Yizhou CHAO, Shanghai (CN); Yanchao CHEN, Shanghai (CN); Na XU, Shanghai (CN); Minhua ZHANG, Shanghai (CN)

(73) Assignee: Conopco, Inc., d/b/a UNILEVER, Englewood Cliffs, NJ (US)

(21) Appl. No.: 18/693,779

(22) PCT Filed: Sep. 20, 2022
(86) PCT No.: PCT/EP2022/076114

§ 371 Date: Mar. 20, 2024

(30) Foreign Application Priority Data
Sep. 22, 2021 (WO) PCT/CN2021/119620
Nov. 4, 2021 (EP) 21206334.1

(51) Int. Cl. C11D 3/00; C11D 3/04; C11D 3/10; C11D 3/12; C11D 3/20; C11D 3/30; C11D 3/34; C11D 17/00

(52) U.S. Cl. CPC C11D 3/001; C11D 3/046; C11D 3/10; C11D 3/126; C11D 3/2082; C11D 3/2086; C11D 3/30; C11D 3/349; C11D 17/0047

(57) ABSTRACT

A solid fabric softening composition is disclosed comprising a disintegrant system and from 5 to 65% by weight of a quaternary ammonium compound having a structure represented by formula (I): (R¹)(R²)—N⁺—[(CH₂)ₙ—Z—R³][(CH₂)ₘ—Y—R⁴]A⁻, wherein each of R¹ and R² is independently a C₁-C₄ alkyl group or a C₂ to C₄ alkenyl group; each R³ and R⁴ is independently a C₇ to C₂₇ alkyl group or alkenyl group; each of Z and Y is independently —O—(O)C— or —C(O)—O—; m and n are each independently a number from 1 to 4; A⁻ is an anionic counterion selected from methyl sulfate, ethyl sulfate, methanesulfonate, ethanesulfonate, sulfate, phosphate, nitrate, formate, carbonate, benzoate, tosylate, acetate, lactate, citrate, chloride, bromide, fluoride, iodide, and mixtures thereof, wherein the disintegrant system comprises a combination of salt and acid; and wherein the composition is in the form of a tablet.

### TECHNICAL FIELD OF THE INVENTION

The present invention is in the field of fabric conditioners. The present invention relates to solid fabric softening compositions, preferably tablets. In particular, the present invention relates to a solid fabric softening composition comprising certain quaternary ammonium compounds.

### BACKGROUND OF THE INVENTION

A wide variety of laundry products are available in the market, including detergents, fabric softeners or enhancers, stain removers and bleach. Fabric softener is a popular household cleaning product that is used to reduce harshness in clothes that are dried in air after washing. Fabric softeners typically coat the surface of a fabric with substances that are electrically charged, causing threads to “stand up” from the surface and thereby imparting a softer and fluffier texture.

A typical process of laundering fabric can be divided into three basic steps: washing, rinsing and drying. Most current softening agents used in home fabric softener are either liquid compositions that are released from a special compartment of the washing machine during the rinsing step or softening sheets that are manually introduced during the drying step.

Fabric softeners comprising cationic softening actives are usually not suitable to be applied during the washing step of a laundry process together with a laundry detergent because undesirable interactions will occur between the cationic softening active and anionic surfactants in the detergent, which leads to little or no softening benefit.

Furthermore, consumers are becoming more conscious of the environmental impact of the products they use. In particular, consumers are concerned with the vast amount of packaging used in their everyday lives. There is a need for more concentrated products, which can provide the same consumer benefits, but with a lower environmental impact.

One solution is to use solid products which have the dual benefit of firstly not requiring the transport of large quantities of water and secondly having reduced packaging requirements.

Compositions in form of tablets become increasingly popular with consumers as they offer simple dosing, easy storage and handling. However, a problem associated with tablets is that they are usually added directly into the drum of a washing machine during the wash sub-cycle. They would start to dissolve in the washing step and the released fabric softening actives may not survive until the rinsing step. Another problem which can arise with the tablets is the deposition of un-dissolved residues remaining on the laundry or in the washing machine (e.g., on the washing machine door glass or the rubber ring) when the wash is complete, resulting in poor user experience for consumers. Furthermore, it is also desirable that the tablets have sufficient strength to maintain mechanical stability. “Mechanical stability”, as used herein, means the tablets maintain their shapes under the conditions that are common in production, transportation and/or storage, i.e. that of neither disintegrating into small pieces nor being irreversibly deformed in the temperature ranges or under the action of forces that are common in production, transportation and/or storage.

Furthermore, the dissolution behavior of the solid fabric softening composition is also important to consumers.

Therefore, there remains a need for a solid fabric softening composition which can be applied in the washing step of the laundry process with a laundry detergent to provide excellent softening benefit and there is still a need to improve other characteristics of such compositions.

### SUMMARY OF THE INVENTION

In a first aspect, the present invention is directed to a solid fabric softening composition comprising:
(a) a disintegrant system; and
(b) from 5 to 65% by weight of a quaternary ammonium compound having a structure represented by formula (I)

(R¹)(R²)—N⁺—[(CH₂)ₙ—Z—R³][(CH₂)ₘ—Y—R⁴]A⁻ (1)
wherein each of R¹ and R² is independently a C₁-C₄ alkyl group or a C₂ to C₄ alkenyl group; each R³ and R⁴ is independently a C₇ to C₂₇ alkyl group or alkenyl group; each of Z and Y is independently —O—(O)C— or —C(O)—O—; m and n are each independently a number from 1 to 4; A⁻ is an anionic counterion selected from methyl sulfate, ethyl sulfate, methanesulfonate, ethanesulfonate, sulfate, phosphate, nitrate, formate, carbonate, benzoate, tosylate, acetate, lactate, citrate, chloride, bromide, fluoride, iodide, and mixtures thereof;
wherein the disintegrant system comprises a combination of salt and acid; and
wherein the composition is in the form of a tablet

In a second aspect, the present invention is directed to a method of softening fabrics comprising the steps of:
(i) providing fabrics in a washing machine; and
(ii) contacting the fabrics with the solid fabric composition of any embodiment of the first aspect during a wash sub-cycle of the washing machine.

In a third aspect, the present invention is directed to use of the solid fabric softening composition of any embodiment of the first aspect to soften fabrics during the washing step of a laundry process.

All other aspects of the present invention will more readily become apparent upon considering the detailed description and examples which follow.

### DETAILED DESCRIPTION OF THE INVENTION

Except in the examples, or where otherwise explicitly indicated, all numbers in this description indicating amounts of material or conditions of reaction, physical properties of materials and/or use may optionally be understood as modified by the word “about”.

All amounts are by weight of the final composition, unless otherwise specified.

It should be noted that in specifying any range of values, any particular upper value can be associated with any particular lower value.

For the avoidance of doubt, the word “comprising” is intended to mean “including” but not necessarily “consisting of” or “composed of”. In other words, the listed steps or options need not be exhaustive.

The disclosure of the invention as found herein is to be considered to cover all embodiments as found in the claims as being multiply dependent upon each other irrespective of the fact that claims may be found without multiple dependency or redundancy.

Where a feature is disclosed with respect to a particular aspect of the invention (for example a composition of the invention), such disclosure is also to be considered to apply to any other aspect of the invention (for example a method of the invention) mutatis mutandis.

The solid fabric softening composition of the present invention can be used as a conventional softening composition after the washing step, but it is particularly suited for use during the washing step of a laundry process.

### Quaternary Ammonium Compound

The solid fabric softening composition comprises from 5 to 65% by weight of a quaternary ammonium compound having a structure represented by formula (I):

(R¹)(R²)—N⁺—[(CH₂)ₙ—Z—R³][(CH₂)ₘ—Y—R⁴]A⁻ (I)
wherein each of R¹ and R² is independently a C₁-C₄ alkyl group or a C₂ to C₄ alkenyl group; each R³ and R⁴ is independently a C₇ to C₂₇ alkyl group or alkenyl group; each of Z and Y is independently —O—(O)C— or —C(O)—O—; m and n are each independently a number from 1 to 4; A⁻ is an anionic counterion selected from methyl sulfate, ethyl sulfate, methanesulfonate, ethanesulfonate, sulfate, phosphate, nitrate, formate, carbonate, benzoate, tosylate, acetate, lactate, citrate, chloride, bromide, fluoride, iodide, and mixtures thereof.

Preferably each of R¹ and R² is independently a C₁-C₄ alkyl group, more preferably a methyl or ethyl group, most preferably a methyl group.

R³ and R⁴ may be linear or branched. Preferably each of R³ and R⁴ is independently a linear C₇ to C₂₇ alkyl or alkenyl group, more preferably a linear C₁-C₂₃ alkyl or alkenyl group, more preferably still a C₁₃ to C₂₁ alkyl or alkenyl group, even more preferably a linear C₁₅ to C₁₉ alkyl or alkenyl group, most preferably a linear C₁₅ to C₁₇ alkyl or alkenyl group. It is especially preferred that each of R³ and R⁴ is independently a linear alkenyl group.

Preferably R³ and R⁴ are identical groups.

Preferably each of Z and Y is independently —O—(O)C— (i.e. an ester group bound to R³ or R⁴ via its carbon atom).

Preferably m and n are each independently a number from 1 to 2, more preferably m and n are each independently 2.

A⁻ is an anionic counterion to the positive charge on the quaternary nitrogen group, which provides electrical neutrality. Preferably A⁻ is a chloride or methylsulfate.

Preferably the quaternary ammonium compound of formula (I) is diethylester dimethyl ammonium chloride. Preferably each of R³ and R⁴ of the diethylester dimethyl ammonium chloride is independently a linear C₇ to C₂₇ alkyl or alkenyl group, more preferably a linear C₇ to C₂₇ alkenyl group.

It is particularly preferred that each of R³ and R⁴ of the diethylester dimethyl ammonium chloride is independently a linear C₁₅ to C₁₉ alkyl or alkenyl group, more preferably a linear C₁₅ to C₁₇ alkyl or alkenyl group. Preferably each of R³ and R⁴ is independently a linear alkenyl group.

The iodine value of the quaternary ammonium compound of formula (I) for use in the present invention is preferably from 0 to 80, more preferably from 0 to 65, and most preferably from 0 to 60. The iodine value is the amount of iodine in grams consumed by the reaction of the double bonds of 100 g of fatty acid, as determined by the method of ISO 3961. “Fatty acid”, as used herein, refers to aliphatic monocarboxylic acids having 8 to 28 carbon atoms. The iodine value, as used herein, refers to the iodine value of the parent fatty acid used to produce the quaternary ammonium compound. The iodine value may be chosen as appropriate. Essentially saturated material having an iodine value of from 0 to 5, preferably from 0 to 1 may be used in the compositions of the invention. Such materials are known as “hardened” quaternary ammonium compounds.

It is especially preferred that the iodine value of the quaternary ammonium compound of formula (I) ranges from 0 to 60, more preferably 12 to 58, most preferably from 18 to 56.

If there is a mixture of quaternary ammonium compounds present in the composition, the iodine value, referred to above, represents the mean iodine value of the parent fatty acyl compounds or fatty acids of all of the quaternary ammonium compounds present. Likewise, if there is any saturated quaternary ammonium compounds present in the composition, the iodine value represents the mean iodine value of the parent acyl compounds or fatty acids of all of the quaternary ammonium compounds present.

An example of the quaternary ammonium compounds of formula (I) suitable for use in the present invention is commercially available from Solvay under the tradename Fentacare BM258.

The solid fabric softening composition of the present invention comprises the quaternary ammonium compound of formula (I) at least 5% by weight of the composition, preferably at least 10%, more preferably at least 15%, and most preferably at least 20% by weight of the composition. The solid fabric softening composition of the present invention comprises the quaternary ammonium compound of formula (I) no greater than 65% by weight of the composition, preferably no greater than 60%, more preferably no greater than 55% and most preferably no greater than 50% by weight of the composition. The solid fabric softening composition of the present invention comprises the quaternary ammonium compound of formula (I) from 5 to 65% by weight of the composition, preferably from 10 to 60%, more preferably from 15 to 55% and most preferably from 20 to 50% by weight of the composition.

### Disintegrant System

The solid fabric softening composition of the present invention comprises a disintegrant system. Disintegrant system, as used herein, refers to materials which are added to the solid composition to make it disintegrate and thus release the actives on contact with water. The solid fabric softening composition of the present invention preferably comprises from 10 to 80% by weight of the disintegrant system, more preferably from 20 to 75%, even more preferably from 30 to 65%, even more preferably from 35 to 60%, even more preferably from 40 to 60%, and most preferably from 42 to 60% by weight of the disintegrant system.

The disintegrant system comprises a combination of salt and acid.

Preferably the acid is organic acids. The organic acid suitable for use in the solid fabric softening composition of the present invention can be any organic acid. Particularly good results were achieved with organic acids being polyacids (i.e. acids having more than one carboxylic acid group), and more particularly with di- or tricarboxylic organic acids. The organic acid used in the invention has a weight average molecular mass of at most 500 Dalton, more preferably of at most 400 Dalton and most preferably of at most 300 Dalton, the molecular mass being based on the free acid equivalent. In any case, preferably the organic acid is not a polymer-based acid. The organic acid employed in accordance with the invention preferably comprises 3 to 25 carbon atoms, more preferably 4 to 15 carbon atoms.

In view of consumer acceptance and reducing environmental impact, the organic acids preferably are those which are also found naturally occurring, such as in plants. Examples of suitable organic acids include acetic acid, citric acid, aspartic acid, lactic acid, adipic acid, succinic acid, glutaric acid, gluconic acid, malic acid, tartaric acid, maleic acid, fumaric acid, saccharic acid, their salts or mixtures thereof. Of particular interest are citric acid, aspartic acid, acetic acid, lactic acid, succinic acid, glutaric acid, gluconic acid, their salts or mixtures thereof. Most preferably, the organic acid is citric acid, succinic acid, their salts or a mixture thereof.

Preferably, the solid fabric softening composition of the present invention comprises from to 50% by weight of the acid, more preferably from 10 to 40%, even more preferably from 12 to 35% and most preferably from 15 to 30% by weight of the acid.

Preferably, the salt is water soluble. “Water soluble”, as used in the context of the present invention, means a material that dissolves in water to give a solution with a concentration of at least 0.1 moles per litre. The salt preferably comprises carbonate salts, more preferably carbonate salts of mono or divalent alkali metals, even more preferably carbonate salts of mono alkali metals wherein the mono alkali metal is sodium or potassium.

Preferably the carbonate salt comprises sodium carbonate, sodium bicarbonate, sodium glycine carbonate, potassium carbonate, potassium bicarbonate, potassium glycine carbonate or mixtures thereof. More preferably the carbonate salt comprises sodium carbonate, sodium bicarbonate, potassium carbonate, potassium bicarbonate or mixtures thereof. Most preferably the carbonate salt comprises sodium carbonate, sodium bicarbonate or mixtures thereof.

It is preferred that the amount of carbonate salt is related to the amount of acid. More specifically it is desired that the weight ratio of the carbonate salt to the acid is from 1:10 to 10:1, more preferably from 1:3 to 3:1, even more preferably from 1:2 to 2:1.

Preferably the salt also comprises an additional non-carbonate salt. The additional non-carbonate salt may help reduce the dissolution time of the solid fabric softening composition in water during wash. Suitable non-carbonate salt comprises sodium chloride, potassium chloride, magnesium sulfate or mixtures thereof. Sodium chloride is particularly preferred.

The solid fabric softening composition preferably comprises from 1 to 20% by weight of the non-carbonate salt, more preferably from 5 to 18%, and most preferably from 8 to 15% by weight of the non-carbonate salt.

### Other Fabric Softening Actives

The quaternary ammonium compound of formula (I) may be present in the composition as a fabric softening active, which refers to any material known to soften fabrics. The solid fabric softening composition may comprise other fabric softening active in addition to the quaternary ammonium compounds of formula (I). Examples of suitable fabric softening actives include other quaternary ammonium compounds in addition to those of formula (I), cationic polymers, glycerides, clays or mixtures thereof.

It is particularly preferred that the fabric softening active comprises or is a clay. A preferred clay is smectite clay. Smectite clays include alkali and alkaline earth metal montmorillonites, saponites and hectorites. There are two distinct classes of smectite-type clays; in the first class of smectites, aluminium oxide is present in the silicate crystal lattice; in the second class of smectites, magnesium oxide is present in the silicate crystal lattice. The general formulas of these smectites are Al₂ (Si₂O₅)₂ (OH)₂ and Mg₃ (Si₂O₅)(OH)₂, for the aluminium and magnesium oxide type clay, respectively.

Smectites clay mineral containing materials useful in the present invention include dioctahedral and trioctahedral three layer smectite clays, ideally of the calcium and/or sodium montmorillonite type. Most preferably the clay is a bentonite such as a montmorillonite.

The clays used herein are impalpable, i.e., have a particle size which cannot be perceived tactilely. Impalpable clays have particle sizes below 50 microns. The clays used herein have a particle size range of from 5 microns to 50 microns.

Preferably the clays have an ion-exchange capacity of at least 50 meq per 100 grams of clay, more preferably 70 meq/100 g, and are impalpable in terms of particle size (from 5-50 microns).

The clays may be present in the solid softening composition in an amount from 0.1 to 15%, preferably from 1 to 10% and more preferably from 2 to 6% by weight of the composition. When the solid softening composition comprises a clay, the weight ratio of clay to the quaternary ammonium compound of formula (I) is preferably from 1:20 to 1:3, more preferably from 1:10 to 1:5.

The solid fabric softening composition may comprise a quaternary ammonium compound having more than one long carbon chain, i.e. more than one carbon chain of 10 carbon atoms or more in length, which is in addition to the quaternary ammonium compound of formula (I).

A first group of suitable quaternary ammonium compound is ester-linked triethanolamine (TEA) quaternary ammonium compounds comprising a mixture of mono-, di- and tri-ester linked components, which may be represented by formula (II):

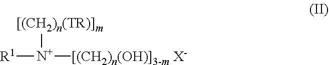

wherein each R is independently a C₅ to C₃₅ alkyl or alkenyl group; R¹ represents a C₁, to C₄ alkyl, C₂ to C₄ alkenyl or a C₁, to C₄ hydroxyalkyl group; T may be either O—CO. (i.e. an ester group bound to R via its carbon atom), or may alternatively be CO—O (i.e. an ester group bound to R via its oxygen atom); n is a number from 1 to 4; m is a number from 1, 2, or 3; and X⁻ is an anionic counterion, such as a halide or alkyl sulphate, e.g. chloride or methylsulfate. Di-esters variants of formula II (i.e. m=2) are preferred and typically have mono- and tri-ester analogues associated with them.

Suitable actives include soft quaternary ammonium actives such as Stepantex VT90, Rewoquat WE18, Rewoquat WE28 SH (ex-Evonik) and Tetranyl L1/90N, Tetranyl L190 SP and Tetranyl L190 S (all ex-Kao), and Fentacare TEP 88L (ex-Solvay).

Also suitable are actives rich in the di-esters of triethanolammonium methylsulfate, otherwise referred to as “TEA ester quats”.

Commercial examples include Preapagen™ TQL (ex-Clariant), and Tetranyl™ AHT-1 (ex-Kao), (both di-[hardened tallow ester] of triethanolammonium methylsulfate), AT-1 (di-[tallow ester] of triethanolammonium methylsulfate), and L5/90 (di-[palm ester] of triethanolammonium methylsulfate), (both ex-Kao), and Rewoquat™ WE15 (a di-ester of triethanolammonium methylsulfate having fatty acyl residues deriving from C₁₀-C₂₀ and C₁₆-C₁₈ unsaturated fatty acids) (ex-Evonik).

A second group of suitable quaternary ammonium compound is represented by formula (III):

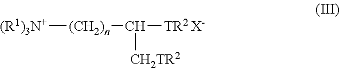

wherein each R¹ group is independently a C₁, to C₄ alkyl, hydroxyalkyl or a C₂ to C₄ alkenyl group; and wherein each R² group is independently a C₈ to C₂₈ alkyl or alkenyl groups; and wherein n, T, and X⁻ are as defined above.

Preferred materials of this second group include 1,2 bis[tallowoyloxy]-3-trimethylammonium propane chloride, 1,2 bis[hardened tallowoyloxy]-3-trimethylammonium propane chloride, 1,2-bis[oleoyloxy]-3-trimethylammonium propane chloride, and 1,2 bis[stearoyloxy]-3-trimethylammonium propane chloride. Such materials are described in U.S. Pat. No. 4,137,180 (Lever Brothers). Preferably, these materials also comprise an amount of the corresponding mono-ester.

A third group of suitable quaternary ammonium compound is represented by formula (IV)

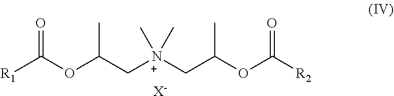

wherein R¹ and R² are each independently a Cao to C₂₂ alkyl or alkenyl group, preferably a C₁₄ to C₂₀ alkyl or alkenyl group. X⁻ is as defined above.

A fourth type of suitable quaternary ammonium compound is represented by formula (V):

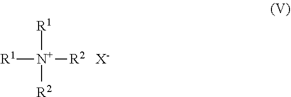

wherein each R¹ is independently a C₁, to C₄ alkyl group or a C₂ to C₄ alkenyl group; each R² is independently a C₈ to C₂₈ alkyl or alkenyl groups; and X⁻ is as defined above.

When the solid fabric softening composition comprises other quaternary ammonium compounds in addition to the quaternary ammonium compound of formula (I), the composition typically comprises less than 10% by weight of the additional quaternary ammonium compound, more preferably less than 5% and most preferably less than 1%. It is especially preferred that the composition does not comprise other quaternary ammonium compound in addition to the quaternary ammonium compound of formula (I).

The fabric softening active may be a cationic polymer. Suitable cationic polymers typically contain cationic nitrogen-containing groups such as quaternary ammonium or protonated amino groups. The cationic protonated amines can be primary, secondary, or tertiary amines (preferably secondary or tertiary). The average molecular weight of the cationic polymer is preferably from 5,000 to 10 million.

The cationic polymer preferably has a cationic charge density of from 0.2 meq/gm to 7 meq/gm. The term “cationic charge density” in the context of this invention refers to the ratio of the number of positive charges on a monomeric unit of which a polymer is comprised to the molecular weight of the monomeric unit. The charge density multiplied by the polymer molecular weight determines the number of positively charged sites on a given polymer chain.

The cationic nitrogen-containing moiety of the cationic polymer is generally present as a substituent on all, or more typically on some, of the repeat units thereof.

The cationic polymer may be a homo-polymer or co-polymer of quaternary ammonium or cationic amine-substituted repeat units, optionally in combination with non-cationic repeat units. Particularly suitable cationic polymers for use in the invention include cationic polysaccharide polymers, such as cationic cellulose derivatives, cationic starch derivatives, and cationic guar gum derivatives.

A particularly suitable type of cationic polysaccharide polymer that can be used is a cationic guar gum derivative, such as guar hydroxypropyltrimethylammonium chloride, (commercially available from Rhodia® in their JAGUAR® trademark series). Examples of such materials are JAGUAR® C13S, JAGUAR® C14, JAGUAR® C15 and JAGUAR® C17.

Suitable further cationic polymers include, for example, copolymers of vinyl monomers having cationic amine or quaternary ammonium functionalities with water soluble spacer monomers such as (meth)acrylamide, alkyl and dialkyl (meth) acrylamides, alkyl (meth)acrylate, vinyl caprolactone and vinyl pyrrolidine. The alkyl and dialkyl substituted monomers preferably have C1-C7 alkyl groups, more preferably C1-C3 alkyl groups.

Other suitable spacers include vinyl esters, vinyl alcohol, maleic anhydride, propylene glycol and ethylene glycol.

A further group of suitable cationic polymers are cationic proteins. For example cationic derivatives of insulin, such as quatin 350 and quatin 680 ex Cosun Biobased products.

The fabric softening active may be a glyceride. Glycerides are formed from glycerol and one, two or three fatty acid chains. Preferably the glyceride is a triglyceride. Glycerides may be naturally derived in plants or animals or synthetic. Examples of suitable glycerides include castor oil, triglycerides of palm oil, triglycerides of sunflower oil and triglycerides of tallow.

### Co-Active

The solid fabric softening composition of the present invention may comprise a co-active. The co-active may aid the dissolution of the softening actives or even provide additional softening benefits.

Suitable co-active includes, for example, fatty alcohols, single-chain cationic surfactants, non-ionic surfactants, polyethylene glycols or mixtures thereof. Fatty alcohols are most preferred. Fatty alcohols which may be employed include tallow alcohol or vegetable alcohol, particularly preferred are hardened tallow alcohol or hardened vegetable alcohol (available under the trade names Stenol™ and Hydrenol™, ex BASF and Laurex™ CS, ex Huntsman). Preferably the fatty alcohol has a fatty chain length of C₁₂ to C₂₂, more preferably C₁₄ to C₂₀. Cetostearyl alcohol is particularly preferred. The fatty alcohol may be present in the solid softening composition in an amount from 0.1 to 10%, preferably from 0.5 to 8%, more preferably from 1% to 5% by weight of the composition. The co-active may be a single chain cationic surfactant. The single chain cationic surfactant preferably has the general formula (VI):

(R¹)₃—N⁺—R² X⁻ (VI)

Wherein each R¹ independently comprises 1 to 6 carbon atoms, selected from alky, alkenyl, aryl or combinations thereof. Each R¹ may independently comprise hydroxy groups. Preferably at least two of the R¹ groups correspond to a methyl group.

Wherein R² comprises at least 10 carbon atoms. The carbon atoms may be in the form of an alky, alkenyl, aryl or combinations thereof. Preferably the single chain cationic surfactant comprises at least 12 carbon atoms, preferably at least 14 and most preferably at least 16. R² may further comprise additional functional groups such as ester groups or hydroxy groups.

X⁻ is an anionic counterion, such as a halide or alkyl sulphate, e.g. chloride or methylsulfate.

Preferred cationic surfactants include hydroxyethyl laurdimonium chloride, cetyltrimethylammonium chloride (CTAC), behentrimonium chloride (BTAC), an alkyl dimethyl hydroxyethyl ammonium chloride such as Praepagen HY ex Clariant GmbH.

The co-active may be a non-ionic surfactant. Suitable non-ionic surfactants include addition products of ethylene oxide and/or propylene oxide with fatty alcohols, fatty acids and fatty amines. Any of the alkoxylated materials of the particular type described hereinafter can be used as the non-ionic surfactant.

Suitable surfactants are substantially water soluble surfactants of the general formula (VII):

R—Y—(C₂H₄O)_{z}—CH₂—CH₂—OH (VII)
where R is selected from the group consisting of primary, secondary and branched chain alkyl and/or acyl hydrocarbyl groups; primary, secondary and branched chain alkenyl hydrocarbyl groups; and primary, secondary and branched chain alkenyl-substituted phenolic hydrocarbyl groups; the hydrocarbyl groups having a chain length of from 8 to about 25, preferably 10 to 20, e.g. 14 to 18 carbon atoms.

In the general formula for the ethoxylated non-ionic surfactant, Y is typically:

—O—,—C(O)O—,—C(O)N(R)— or —C(O)N(R)R—
in which R has the meaning given above for formula (VII), or can be hydrogen; and Z is a number at least about 8, preferably at least about 10 or 11.

Preferably the non-ionic surfactant has an HLB of from about 7 to about 20, more preferably from 10 to 18, e.g. 12 to 16. Genapol™ C200 (Clariant) based on coco chain and 20 EO groups is an example of a suitable non-ionic surfactant.

A class of preferred non-ionic surfactants include addition products of ethylene oxide and/or propylene oxide with fatty alcohols, fatty acids and fatty amines. These are preferably selected from addition products of (a) an alkoxide selected from ethylene oxide, propylene oxide and mixtures thereof with (b) a fatty material selected from fatty alcohols, fatty acids and fatty amines.

A second class of preferred non-ionic surfactants are polyethylene glycol ethers of glycerine. Such as Glycereth-6 Cocoate, Glycereth-7 Cocoate and Glycereth-17 Cocoate.

Preferably the non-ionic surfactant is selected from addition products of ethylene oxide and/or propylene oxide with fatty alcohols, fatty acids and fatty amines and polyethylene glycol ethers of glycerine.

Suitable non-ionic surfactants are available commercially as Lutensol™ AT25 ex. BASF based on C16:18 chain and 25 EO groups is an example of a suitable non-ionic surfactant. Other suitable surfactants include Renex 36 (Trideceth-6), ex Croda; Tergitol 15-S3, ex Dow Chemical Co.; Dihydrol LT7, ex Thai Ethoxylate ltd; Cremophor C040, ex BASF and Neodol 91-8, ex Shell; LEVENOL® F-200, LEVENOL® C-301 and LEVENOL® C-201 ex. Kao.

### Chelating Agents

The solid fabric softening composition of the present invention preferably comprises chelating agents. Aminopolycarboxylates are particularly preferred. Suitable aminopolycarboxylates include glutamic acid N,N-diacetic acid (GLDA), methylglycinediacetic acid (MGDA), ethylenediaminedisuccinic acid (EDDS), iminodisuccinic acid (IDS), iminodimalic acid (IDM), ethylenediaminetetraacetic acid (EDTA), nitrilotriacetic acid (NTA), iminodiacetic acid (IDA), diethylenetriaminepentaacetic acid (DTPA), hydroxyethyliminodiacetic acid (HEIDA) aspartic acid diethoxysuccinic acid (AES) aspartic acid-N,N-diacetic acid (ASDA), hydroxyethylene-diaminetetraacetic acid (HEDTA), hydroxyethylethylene-diaminetriacetic acid (HEEDTA), iminodifumaric (IDF), iminoditartaric acid (IDT), iminodimaleic acid (IDMAL), ethylenediaminedifumaric acid (EDDF), ethylenediaminedimalic acid (EDDM), ethylenediamineditartaric acid (EDDT), ethylenediaminedimaleic acid and (EDDMAL), dipicolinic acid or mixture thereof.

Preferred aminopolycarboxylates are GLDA, MGDA, EDDS, IDS, IDM or a mixture thereof, more preferred are GLDA, MGDA, EDDS or a mixture thereof and even more preferred are GLDA and MGDA or a mixture thereof. Of these GLDA is especially preferred as it can be made from bio-based materials (e.g. monosodium glutamate, which itself can be made as by-product from corn fermentation). Also, GLDA itself is highly biodegradable. MGDA is more preferred in view of it being somewhat less hygroscopic, which improves stability of the composition during storage.

The aminopolycarboxylates may be present in the solid fabric softening composition in an amount from 0.1 to 20%, preferably from 0.5 to 8% and more preferably from 1 to 5% by weight of the composition. The weight as based on the free acid equivalent. The aminopolycarboxylates can be in the form of an acid or a corresponding salt, which is then preferably an alkali metal salt and more preferably a sodium salt.

The following table shows how the free acid equivalent concentrations can be calculated for some (anhydrous) aminopolycarboxylates and (anhydrous) acid salts.

| | Wt. % | Conversion | Wt. % free acid |
|---|---|---|---|
| | salt | factor | equivalent |
| GLDA (tetrasodium salt) | 50 | 263.1/351.1 | 37.5 |
| MGDA (trisodium salt) | 50 | 205.1/271.1 | 37.8 |

### Perfume

The solid fabric softening composition of the present invention may comprise perfume materials to impart fragrance to a fabric. The perfume materials are preferably solid. Preferably, the compositions comprise from 0.1 to 30% by weight of perfume materials i.e. free perfume and/or perfume microcapsules. As is known in the art, free perfumes and perfume microcapsules provide the consumer with perfume hits at different points during the wash cycle. It is particularly preferred that the compositions of the present invention comprise a combination of both free perfume and perfume microcapsules.

Preferably the compositions of the present invention comprise 0.1 to 20% perfume materials, more preferably 1 to 15% perfume materials, most preferably 2 to 10% perfume materials.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

### Free Perfumes:

The compositions of the invention preferably comprise 0.1 to 15% free perfume, more preferably 0.5 to 8% of free perfume by weight of the compositions.

Particularly preferred perfume components are blooming perfume components and substantive perfume components. Blooming perfume components are defined by a boiling point less than 250° C. and a Log P greater than 2.5. Substantive perfume components are defined by a boiling point greater than 250° C. and a Log P greater than 2.5. Boiling point is measured at standard pressure (760 mm Hg). Preferably, a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

### Perfume Microcapsules:

The compositions of the present invention preferably comprise 0.1 to 15% of perfume microcapsules, more preferably 0.5 to 8% of perfume microcapsules by weight of compositions. The weight of microcapsules is of the material as supplied.

When perfume components are encapsulated, suitable encapsulating materials, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof. Particularly preferred materials are aminoplast microcapsules, such as melamine formaldehyde or urea formaldehyde microcapsules.

Perfume microcapsules of the present invention can be friable microcapsules and/or moisture activated microcapsules. By friable, it is meant that the perfume microcapsule will rupture when a force is exerted. By moisture activated, it is meant that the perfume is released in the presence of water. The particles of the present invention preferably comprise friable microcapsules. Moisture activated microcapsules may additionally be present. Examples of a microcapsules which can be friable include aminoplast microcapsules.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a Log P greater than 2.5. Substantive perfume components are defined by a boiling point greater than 250° C. and a Log P greater than 2.5. Boiling point is measured at standard pressure (760 mm Hg). Preferably, a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume components may be applied.

The microcapsules may comprise perfume components and a carrier for the perfume ingredients, such as zeolites or cyclodextrins.

### Filler

The solid fabric softening composition may comprise a water soluble and/or water dispersible filler material. The filler provides beneficial properties such as improving the flow of the powder and providing a carrier for any liquid ingredients. When selecting a suitable filler, consideration must be made to the desirable pH of the composition.

Preferably the solid fabric softening composition comprises from 1 to 50% by weight of the filler materials, more preferably from 3 to 35%, even more preferably from 5 to 25% and most preferably from 10 to 20%, based on total weight of the composition.

Suitable water soluble filler materials comprise water-soluble alkali metal salt, water-soluble alkaline earth metal salt, water-soluble organic alkali metal salt, water-soluble organic alkaline earth metal salt, water-soluble carbohydrate, water-soluble silicate, water-soluble urea or mixtures thereof. Preferably the water-soluble filler materials comprise alkali metal chlorides, alkali metal sulfates, alkaline earth metal chlorides, alkaline earth metal sulfates or mixtures thereof. More preferably the water-soluble filler materials comprise sodium sulfate, magnesium sulfate, sodium chloride or mixtures thereof. Sodium chloride is most preferred.

Suitable water dispersible filler materials comprise starch, modified starch, cellulose, modified cellulose, zeolite, silica, clay or mixtures thereof. Preferably the water dispersible filler materials comprise starch, modified starch or mixtures thereof. Starch is most preferred. When included, the starch is present in an amount ranging from 1 to 15% by weight of the solid fabric softening composition, more preferably from 1.5 to 10% and most preferably from 2 to 6% by weight of the solid fabric softening composition.

### Other Ingredients

The solid fabric softening composition of the present invention may comprise other ingredients which are common in the art to enhance physical properties and performance in addition to those materials described above. These ingredients include antifoaming agents, insect repellents, shading or hueing dyes, pH buffering agents, perfume carriers, hydrotropes, anti-redeposition agents, soil-release agents, polyelectrolytes, anti-shrinking agents, anti-wrinkle agents, anti-oxidants, dyes, colorants, sunscreens, anti-corrosion agents, drape imparting agents, anti-static agents, sequestrants and ironing aids. The products of the invention may contain pearlisers and/or opacifiers. A preferred sequestrant is HEDP, an abbreviation for Etidronic acid or 1-hydroxyethane 1,1-diphosphonic acid.

### Form of the Solid Fabric Softening Composition

The form of the present invention is tablets. The tablet may have any shape selected from spherical, cubical, rectangular, circular, disc, cylindrical, flower-shaped, hemispherical, compressed hemispherical, lentil-shaped, oblong, star-shaped and any combinations thereof. Preferably the tablets are cylindrical, cubical or rectangular shaped. Cylindrical shaped tablets are particularly preferred. It is preferred that the tablets have a relatively high aspect ratio. Aspect ratio, as used herein, means the ratio between the largest dimension of the tablet divided by the shortest dimension of the tablet. For example, if the tablet has the shape of a cylinder, the aspect ratio is defined as the ratio between the diameter and height of the tablet. Preferably, the aspect ratio of the tablet is from 1.1:1 to 20:1, more preferably from 1.5:1 to 15:1, even more preferably from 2:1 to 10:1, and most preferably from 2.2:1 to 5:1.

The fabric softening tablet is provided as a water soluble or water dispersible unit dose. The tablet preferably has a weight of from 0.5 to 40 grams, more preferably from 1 to 35 grams, even more preferably from 3 to 30 grams, most preferably from 4 to 25 grams. The density of the tablet is preferably from 1 to 1.8 g/cm³, more preferably from 1.1 to 1.5 g/cm³.

It is not preferred that the tablet is wrapped in a water soluble film. It was found that the presence of water soluble film can in some cases lead to residues in the washing machine. The tablet is preferably packaged in a blister pack or a multi-dose container which is preferably equipped with a child-safe locking mechanism.

The solid fabric softening compositions in the form of tablets can be made using known tablet formation methods and equipment, such as those in the field of detergent product manufacturing or machine dishwash tablet manufacturing. In general, the tablet of the present invention can be made by combining the ingredients together and compacting in a tablet mold, by solidifying pre-heated liquid materials in a mold and/or by a combination thereof.

### Use for the Solid Fabric Softening Composition

The solid fabric softening compositions of the present invention are for use in the laundry process. They may be added in the wash sub-cycle or a rinse sub-cycle of a laundry cycle using a washing machine. Preferably they are added in the wash sub-cycle.

Alternatively, the compositions may be used in manual hand washing of fabrics. The solid fabric softening compositions of the present invention enable consumers to achieve softening during the washing step of a laundry process. The compositions may dissolve into water during the wash sub-cycle to form a wash liquor. The solid fabric softening compositions may be used in addition to other laundry products or they may be used as a standalone product.

The solid fabric softening composition may be dosed to a laundry washing machine in a quantity of 1 g to 50 g, preferably from 5 g to 45 g, more preferably from 10 g to 40 g and most preferably from 15 g to 35 g. When the solid fabric softening composition is in the form of tablets, one or more tablets may form a single dose for a laundry wash, depending on the conditions of intended use and the dimensions of the tablets. The solid fabric softening compositions may be dosed by consumers from a package directly into the drum of a washing machine or into a dosing compartment on the washing machine. Preferably, the compositions are directly dosed into the drum of the washing machine.

The solid fabric softening composition, preferably tablets, as described herein may be used in a method of softening fabrics comprising the steps of:
(i) providing fabrics in a washing machine; and
(ii) contacting the fabrics with the solid fabric softening composition during a wash sub-cycle of the washing machine.

The solid fabric softening composition, preferably tablets, as described herein may be used to soften fabrics during the washing step of a laundry process. The composition may be further used to impart fragrance to laundered fabrics during the laundry process. The following examples are provided to facilitate an understanding of the invention. The examples are not intended to limit the scope of the claims.

### EXAMPLES

### Example 1

Solid softening compositions were prepared as shown in table 1. All ingredients are expressed by weight percent of the total formulation.

TABLE 1

| Ingredient | wt. % in composition |
|---|---|
| Starch | 4 |
| Citric acid | 7 |
| Succinic acid | 14 |
| Sodium bicarbonate | 26 |
| Softening active^{a} | 25 |
| Bentonite | 4 |
| Fatty alcohol | 2 |
| MGDA | 2 |
| Sodium chloride | 10 |
| Solid perfume | 6 |

^{a}Softening active as detailed in table 2

### Preparation of Solid Softening Composition in the Form of a Tablet

The ingredients were added one by one into a double-cone mixer and mixed evenly. The resulting powder was collected and compressed to tablet form by a compression roll (20-120 kN). The final tablet weighed 5 grams per tablet.

### Evaluation of Softening Performance

A 1.3 kg ballast load comprised of 6 pieces of cotton T-shirt and 5 pieces of Terry Towelling Squares (30×30 cm size). The towelling squares were mixed in with the cotton T-shirt in a random order within the washing machine so that they are not all together. Four tablets (5 g/tablet) as prepared above were added to the drum of a top loading washing machine followed by the mixed fabrics and finally 40 g of liquid detergent (commercial OMO detergent) was added to the draw of the machine, door was closed and then the machine was set to wash. Wash time was 40 minutes including one-time wash and two times rinses. Once the wash had finished the load was removed from the machine and the terry towelling squares were separated out and lined dried on racks. Once the terry towelling squares were dry then the whole process was repeated again to achieve 3 washes with drying.

The towels were passed on for sensory evaluation without further conditioning. The participants were asked to pick up the test towel in hands and required to gently manipulate it, then gave scores from 0 to 5. A score of 5 is the highest score which corresponds to an excellent softening result. A score of 0 is the lowest score which corresponds to a poor softening result.

The results of the panel evaluation are shown in Table 2.

TABLE 2

| Softening active^{a} | Softness Score |
|---|---|
| Di-esters of triethanolammonium methylsulfate^{b} | 1 |
| Diethylester dimethyl ammonium chloride ^{c} | 4 |

^{b}Fentacare TEP 88L from Solvay
^{c} Fentacare BM258 from Solvay

The softness score above 3 is considered as acceptable. The results showed that the softening tablet comprising a quaternary ammonium compound in accordance with the present invention provided a much better softening benefit.

### Example 2

Solid softening compositions were prepared as shown in table 3. All ingredients are expressed by weight percent of the total formulation.

TABLE 3

Samples (wt. % in composition)

| Ingredient | 1 | A |
|---|---|---|
| Starch | 4 | 4 |
| Citric acid | 7 | — |
| Succinic acid | 14 | — |
| Sodium bicarbonate | 26 | — |
| Sodium sulfate | — | 41 |
| Diethylester dimethyl | 25 | 25 |
| ammonium chloride ^{c} | | |
| Bentonite | 4 | 10 |
| Fatty alcohol | 2 | 2 |
| MGDA | 2 | 2 |
| Sodium chloride | 10 | 10 |
| Solid perfume | 6 | 6 |

The samples were made into tablets according to the method described in Example 1. The final tablet weighed 5 grams per tablet.

### Method to Test Breakage Rate of Tablets

A 350 mL bottle was conditioned at 23+/−2° C./50% RH (relative humidity) for 24 hours. The bottle was filled with around 40 tablets (5 g/tablet) after separating the powder from the tablets with a 20 mesh sieve. The initial weight of the tablets (after separating the powder) was recorded. The bottle was then tightly sealed with a closure. When the bottle was filled with tablets, adjusted the height so that the bottom of the bottle is 1 metre above the ground and then dropped the bottle six times in the following order: oriented the bottle on face and dropped; oriented the bottle on back and dropped; oriented the bottle on top and dropped; oriented the bottle on bottom and dropped; oriented the bottle on one side and dropped; oriented the bottle on the other side and dropped.

After drop, a 20 mesh sieve was used to separate the powder from the tablets. The total weight of powder was recorded. The breakage rate (R_{b}) of tablets was calculated as: R_{b}(%)=(The total weight of powder after drop/The initial weight of the tablets)×100%

The drop test was repeated 5 times for each sample, the average breakage rate of the tablets was calculated and reported in table 4.

TABLE 4

Samples

| | 1 | A |
|---|---|---|
| Breakage rate (%) | 0.65 | 2.13 |

The breakage rate is a parameter to evaluate the strength of tablets under impact. It is considered acceptable if the tablet breakage rate is less than 1%. As shown in table 4, sample 1 had a breakage rate of 0.65% which was within the acceptable range.

1. A solid fabric softening composition comprising:
(a) from 35 to 60% by weight of a disintegrant system; and
(b) from 5 to 65% by weight of a quaternary ammonium compound having a structure represented by formula (I)
(R¹)(R²)—N⁺—[(CH₂)ₙ—Z—R³][(CH₂)ₘ—Y—R⁴]A⁻ (I)
wherein each of R¹ and R² is independently a C₁-C₄ alkyl group or a C₂ to C₄ alkenyl group; each R³ and R⁴ is independently a C₇ to C₂₇ alkyl group or alkenyl group; each of Z and Y is independently —O—(O)C— or —C(O)—O—; m and n are each independently a number from 1 to 4; A⁻ is an anionic counterion selected from methyl sulfate, ethyl sulfate, methanesulfonate, ethanesulfonate, sulfate, phosphate, nitrate, formate, carbonate, benzoate, tosylate, acetate, lactate, citrate, chloride, bromide, fluoride, iodide, and mixtures thereof;
wherein the disintegrant system comprises a combination of salt and acid;
wherein the salt comprises carbonate salts;
wherein the weight ratio of the carbonate salt to the acid is from 1:10 to 10:1; and
wherein the composition is in the form of a tablet.

2. The solid fabric softening composition according to claim 1, wherein the quaternary ammonium compound is diethylester dimethyl ammonium chloride.

3. The solid fabric softening composition according to claim 2, wherein each of R³ and R⁴ of the diethylester dimethyl ammonium chloride is independently a linear C₁₅ to C₁₉ alkyl or alkenyl group.

4. The solid fabric softening composition according to claim 1, wherein the composition comprises the quaternary ammonium compound from 10 to 60% by weight of the composition.

5. The solid fabric softening composition according to claim 1, wherein the acid is organic acid comprising acetic acid, citric acid, aspartic acid, lactic acid, adipic acid, succinic acid, glutaric acid, gluconic acid, malic acid, tartaric acid, maleic acid, fumaric acid, saccharic acid, their salts or mixtures thereof.

6. The solid fabric softening composition according to claim 1, wherein the salt comprises carbonate salts of mono or divalent alkali metals.

7. The solid fabric softening composition according to claim 6 wherein the salt comprises an additional non-carbonate salt, preferably the non-carbonate salt comprises sodium chloride, potassium chloride, magnesium sulfate or mixtures thereof.

8. The solid fabric softening composition according to claim 1, wherein the composition additionally comprises a clay, preferably the clay is a bentonite.

9. The solid fabric softening composition according to claim 1, wherein the composition additionally comprises a chelating agent.

10. The solid fabric softening composition according to claim 1, wherein the composition additionally comprises a perfume material.

11. The solid fabric softening composition according to claim 1, wherein the tablet has a weight of from 0.5 to 40 grams.

12. A method of softening fabrics comprising the steps of:
(i) providing fabrics in a washing machine; and
(ii) contacting the fabrics with the solid fabric composition according to claim 1 during a wash sub-cycle of a washing machine.

13. The method of softening fabrics according to claim 12 wherein the solid fabric softening composition further comprises starch, citric acid, succinic acid, bentonite, fatty alcohol, perfume, chelating agent or a mixture thereof.
